(19) United States
(12) Patent Application Publication
(10) Pub. No.: US 2015/0341961 A1
(43) Pub. Date: Nov. 26, 2015

(54) METHOD AND APPARATUS FOR CHANNEL ACCESS IN WIRELESS LAN SYSTEM

(71) Applicant: LG ELECTRONICS INC., Seoul (KR)

(72) Inventors: Jeongki KIM, Seoul (KR); Yongho SEOK, Seoul (KR); Hangyu CHO, Seoul (KR); Jinsoo CHOI, Seoul (KR)

(73) Assignee: LG ELECTRONICS INC., Seoul (KR)

(21) Appl. No.: 14/758,942

(22) PCT Filed: Jan. 2, 2014
(86) PCT No.: PCT/KR2014/000016

§ 371 Date: Jul. 1, 2015

Related U.S. Application Data
(60) Provisional application No. 61/748,131, filed on Jan. 2, 2013.
(60) Provisional application No. 61/766,700, filed on Feb. 20, 2013.

(51) Int. Cl. H04W 74/08; H04W 72/04

(52) U.S. Cl. CPC H04W 74/0808; H04W 72/0446; H04W 88/02

(57) ABSTRACT

The present invention relates to a wireless communication system and, more particularly, to a method and apparatus for channel access in a wireless LAN system. To perform the abovementioned technical task, the method for performing channel access by a station (STA) in a wireless LAN system, according to one embodiment of the present invention, may comprise the steps of: deferring, if the channel is in an idle state, the transmission of a first frame until a second frame is detected from another station; and transmitting the first frame when the second frame is detected.

### TECHNICAL FIELD

The present disclosure relates to a wireless communication system and, more particularly, to a method and apparatus for channel access in a WLAN system.

### BACKGROUND ART

With recent development of information communication technologies, a variety of wireless communication technologies have been developed. Among such technologies, WLAN allows wireless Internet access at home, in businesses, or in specific service providing areas using a mobile terminal, such as a personal digital assistant (PDA), a laptop computer, and a portable multimedia player (PMP), based on radio frequency technology.

In order to overcome limited communication speed, which has been pointed out as a weak point of WLAN, technical standards have recently introduced a system capable of increasing the speed and reliability of a network while extending a coverage region of a wireless network. For example, IEEE 802.11n supports high throughput (HT) with a maximum data processing speed of 540 Mbps. In addition, Multiple Input Multiple Output (MIMO) technology, which employs multiple antennas for both a transmitter and a receiver in order to minimize transmission errors and optimize data rate, has been introduced.

### DISCLOSURE

### Technical Problem

Machine-to-machine (M2M) communication technology has been discussed as a next generation communication technology. A technical standard to support M2M communication in the IEEE 802.11 WLAN system is also under development as IEEE 802.11ah. In M2M communication, a scenario in which a small amount of data is occasionally communicated at a low speed in an environment including a large number of devices may be considered.

Communication in a WLAN system is performed on a medium shared by all devices. If the number of devices participating in communication such as M2M communication increases, it may take a long time for one device to perform channel access. This may not only result in degradation in overall system performance, but also prevent the devices from saving power.

In the WLAN system, a specific type (or specific mode) station (STA) is allowed to attempt channel access without checking a traffic indication map provided by an access point. If the specific type STA (e.g., a non-TIM STA) performs channel access without recognizing that the channel is used by another STA, unnecessary power consumption may occur in the STA and efficiency in using limited channels, which are resources of a network, may be lowered.

An object of the present invention devised to solve the problem lies in an improved method for channel access that is applicable to a WLAN system.

Objects of the present invention are not limited to the aforementioned objects, and other objects of the present invention which are not mentioned above will become apparent to those having ordinary skill in the art upon examination of the following description.

### Technical Solution

The object of the present invention can be achieved by providing a method for performing channel access by a station (STA) in a wireless local area network (WLAN), the method including deferring, if a channel is idle, transmission of a first frame until a second frame from another STA is detected, and transmitting the first frame when the second frame is detected.

In another aspect of the present invention, provided herein is a station (STA) for performing channel access in a wireless local area network (WLAN), the STA including a transceiver, and a processor, wherein the processor is configured to defer, if a channel is idle, transmission of a first frame until a second frame from another STA is detected, and transmit the first frame using the transceiver when the second frame is detected.

Embodiments of the present invention may include the following details.

Deferring transmission of the first frame may be performed if the channel is determined to be idle when the STA wakes up.

Deferring transmission of the first frame may be performed if the STA transmits the first frame when the STA wakes up, but fails to receive a response frame for the transmitted first frame.

Transmitting the first frame when the STA wakes up may include transmitting the first frame without deferring transmission of the first frame when the channel is determined to be idle.

A timer may be set for the STA, wherein transmission of the first frame may be prohibited while the timer is running.

The first frame may be transmitted when the timer expires before the second frame is detected.

The timer may be stopped when the second frame is detected before the timer expires.

The timer may start when the STA wakes up and transmits the first frame, or when a response frame for the first frame transmitted when the STA wakes up is not received.

Transmitting the first frame when the STA wakes up may include transmitting the first frame without deferring transmission of the first frame when the channel is determined to be idle.

A length of the timer may be set to a maximum transmission opportunity (TXOP) duration.

Transmitting the first frame may include transmitting the first frame after performing a backoff process.

The first frame may be one of a power save (PS)-Poll frame, a trigger frame, a data frame and a request to send (RTS) frame.

The second frame may be either a frame from another STA or a beacon frame from an access point (AP).

The STA may be a non-traffic indication map (TIM) STA.

It is to be understood that both the foregoing general description and the following detailed description of the present invention are exemplary and explanatory and are intended to provide further explanation of the invention as claimed.

### Advantageous Effects

According to embodiments of the present invention, a method and apparatus capable of improving channel access in a WLAN system may be provided.

The effects that can be obtained from the present invention are not limited to the aforementioned effects, and other effects may be clearly understood by those skilled in the art from the descriptions given below.

### DESCRIPTION OF DRAWINGS

The accompanying drawings, which are intended to provide a further understanding of the present invention, illustrate various embodiments of the present invention and together with the descriptions in this specification serve to explain the principle of the invention.

FIG. 1 is a diagram showing an exemplary structure of an IEEE 802.11 system to which the present invention is applicable.

FIG. 2 is a diagram showing another exemplary structure of an IEEE 802.11 system to which the present invention is applicable.

FIG. 3 is a diagram showing still another exemplary structure of an IEEE 802.11 system to which the present invention is applicable.

FIG. 4 is a diagram showing an exemplary structure of a WLAN system.

FIG. 5 illustrates a link setup process in a WLAN system.

FIG. 6 illustrates a backoff process.

FIG. 7 illustrates a hidden node and an exposed node.

FIG. 8 illustrates RTS and CTS.

FIG. 9 illustrates a power management operation.

FIGS. 10 to 12 illustrate operations of a station (STA) having received a TIM in detail.

FIG. 13 is a diagram illustrating collision between transmission by a non-TIM STA and transmission by another STA.

FIG. 14 is a diagram illustrating transmission of a PS-Poll frame by a non-TIM STA according to an embodiment of the present invention.

FIG. 15 is a diagram illustrating transmission of a PS-Poll frame by a non-TIM STA according to another embodiment of the present invention.

FIG. 16 is a diagram illustrating transmission of a PS-Poll frame by a non-TIM STA according to another embodiment of the present invention.

FIG. 17 is a diagram illustrating transmission of a data frame by a non-TIM STA according to an embodiment of the present invention.

FIG. 18 is a diagram illustrating transmission of an RTS frame by a non-TIM STA according to an embodiment of the present invention.

FIGS. 19 and 20 illustrate use of a timer for channel access delay of a non-TIM STA.

FIG. 21 illustrates a method for channel access by a non-TIM STA according to an embodiment of the present invention.

FIG. 22 is a block diagram illustrating a radio frequency apparatus according to an embodiment of the present invention.

### BEST MODE

Hereinafter, exemplary embodiments of the present invention will be described with reference to the accompanying drawings. The detailed description, which will be disclosed along with the accompanying drawings, is intended to describe exemplary embodiments of the present invention and is not intended to describe a unique embodiment through which the present invention can be carried out. The following detailed description includes specific details in order to provide a thorough understanding of the present invention. However, it will be apparent to those skilled in the art that the present invention may be practiced without such specific details.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

Specific terms used in the following description are provided to aid in understanding of the present invention. These specific terms may be replaced with other terms within the scope and spirit of the present invention.

In some instances, well-known structures and devices are omitted in order to avoid obscuring the concepts of the present invention and the important functions of the structures and devices are shown in block diagram form. The same reference numbers will be used throughout the drawings to refer to the same or like parts.

The embodiments of the present invention can be supported by standard documents disclosed for at least one of wireless access systems such as the institute of electrical and electronics engineers (IEEE) 802, 3rd generation partnership project (3GPP), 3GPP long term evolution (3GPP LTE), LTE-advanced (LTE-A), and 3GPP2 systems. For steps or parts of which description is omitted to clarify the technical features of the present invention, reference may be made to these documents. Further, all terms as set forth herein can be explained by the standard documents.

The following technology can be used in various wireless access systems such as systems for code division multiple access (CDMA), frequency division multiple access (FDMA), time division multiple access (TDMA), orthogonal frequency division multiple access (OFDMA), single carrier frequency division multiple access (SC-FDMA), etc. CDMA may be implemented by radio technology such as universal terrestrial radio access (UTRA) or CDMA2000. TDMA may be implemented by radio technology such as global system for mobile communications (GSM)/general packet radio service (GPRS)/enhanced data rates for GSM evolution (EDGE). OFDMA may be implemented by radio technology such as IEEE 802.11 (Wi-Fi), IEEE 802.16 (WiMAX), IEEE 802.20, evolved-UTRA (E-UTRA), etc. For clarity, the present disclosure focuses on 3GPP LTE and LTE-A systems. However, the technical features of the present invention are not limited thereto.

Structure of WLAN System

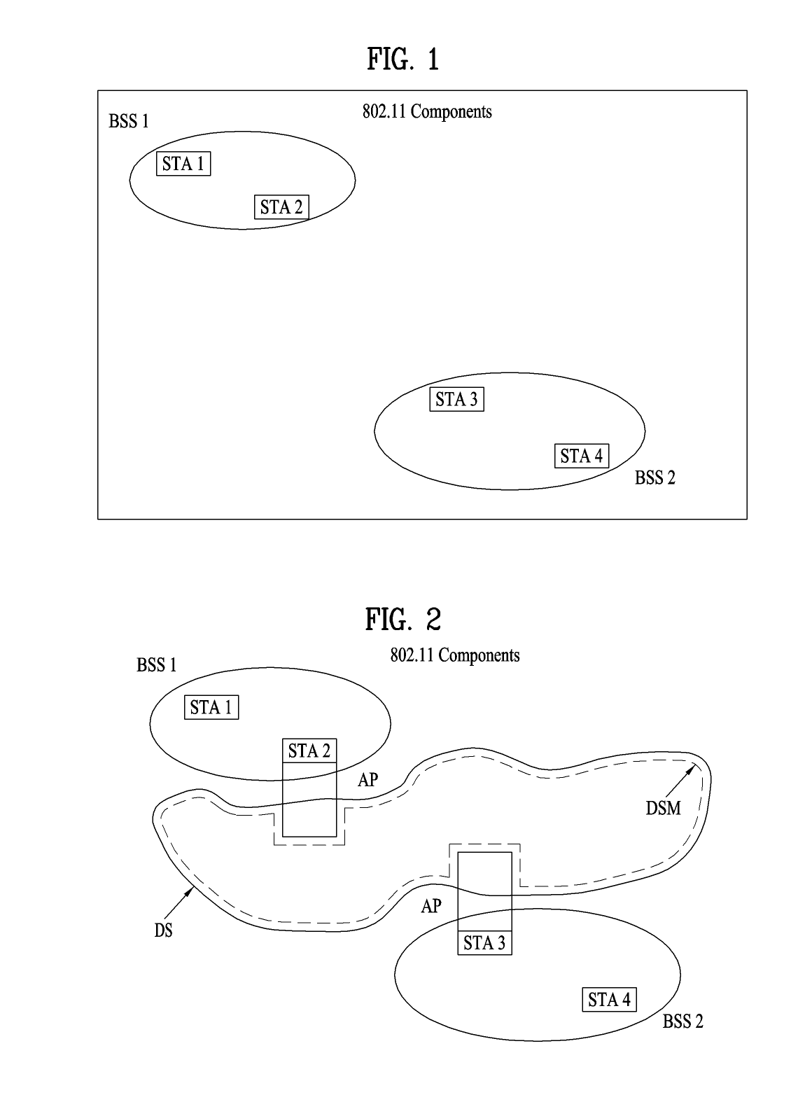

FIG. 1 is a diagram showing an exemplary structure of an IEEE 802.11 system to which the present invention is applicable.

The structure of the IEEE 802.11 system may include a plurality of components. A WLAN which supports transparent station (STA) mobility for a higher layer may be provided by mutual operations of the components. A basic service set (BSS) may correspond to a basic building block in an IEEE 802.11 LAN. In FIG. 1, two BSSs (BSS1 and BSS2) are present and two STAs are included in each of the BSSs (i.e. STA1 and STA2 are included in BSS1 and STA3 and STA4 are included in BSS2). An ellipse indicating the BSS in FIG. 1 may be understood as a coverage area in which STAs included in a corresponding BSS maintain communication. This area may be referred to as a basic service area (BSA). If an STA moves out of the BSA, the STA cannot directly communicate with the other STAs in the corresponding BSA.

In the IEEE 802.11 LAN, the most basic type of BSS is an independent BSS (IBSS). For example, the IBSS may have a minimum form consisting of only two STAs. The BSS (BSS1 or BSS2) of FIG. 1, which is the simplest form and does not include other components except for the STAs, may correspond to a typical example of the IBSS. This configuration is possible when STAs can directly communicate with each other. Such a type of LAN may be configured as necessary instead of being prescheduled and is also called an ad-hoc network.

Memberships of an STA in the BSS may be dynamically changed when the STA becomes an on or off state or the STA enters or leaves a region of the BSS. To become a member of the BSS, the STA may use a synchronization process to join the BSS. To access all services of a BSS infrastructure, the STA should be associated with the BSS. Such association may be dynamically configured and may include use of a distributed system service (DSS).

FIG. 2 is a diagram showing another exemplary structure of an IEEE 802.11 system to which the present invention is applicable. In FIG. 2, components such as a distribution system (DS), a distribution system medium (DSM), and an access point (AP) are added to the structure of FIG. 1.

A direct STA-to-STA distance in a LAN may be restricted by physical (PHY) performance. In some cases, such restriction of the distance may be sufficient for communication. However, in other cases, communication between STAs over a long distance may be necessary. The DS may be configured to support extended coverage.

The DS refers to a structure in which BSSs are connected to each other. Specifically, a BSS may be configured as a component of an extended form of a network consisting of a plurality of BSSs, instead of independent configuration as shown in FIG. 1.

The DS is a logical concept and may be specified by the characteristic of the DSM. In relation to this, a wireless medium (WM) and the DSM are logically distinguished in IEEE 802.11. Respective logical media are used for different purposes and are used by different components. In definition of IEEE 802.11, such media are not restricted to the same or different media. The flexibility of the IEEE 802.11 LAN architecture (DS architecture or other network architectures) can be explained in that a plurality of media is logically different. That is, the IEEE 802.11 LAN architecture can be variously implemented and may be independently specified by a physical characteristic of each implementation.

The DS may support mobile devices by providing seamless integration of multiple BSSs and providing logical services necessary for handling an address to a destination.

The AP refers to an entity that enables associated STAs to access the DS through a WM and that has STA functionality. Data can be moved between the BSS and the DS through the AP. For example, STA2 and STA3 shown in FIG. 2 have STA functionality and provide a function of causing associated STAs (STA1 and STA4) to access the DS. Moreover, since all APs correspond basically to STAs, all APs are addressable entities. An address used by an AP for communication on the WM need not necessarily be identical to an address used by the AP for communication on the DSM.

Data transmitted from one of STAs associated with the AP to an STA address of the AP may be always received by an uncontrolled port and may be processed by an IEEE 802.1X port access entity. If the controlled port is authenticated, transmission data (or frame) may be transmitted to the DS.

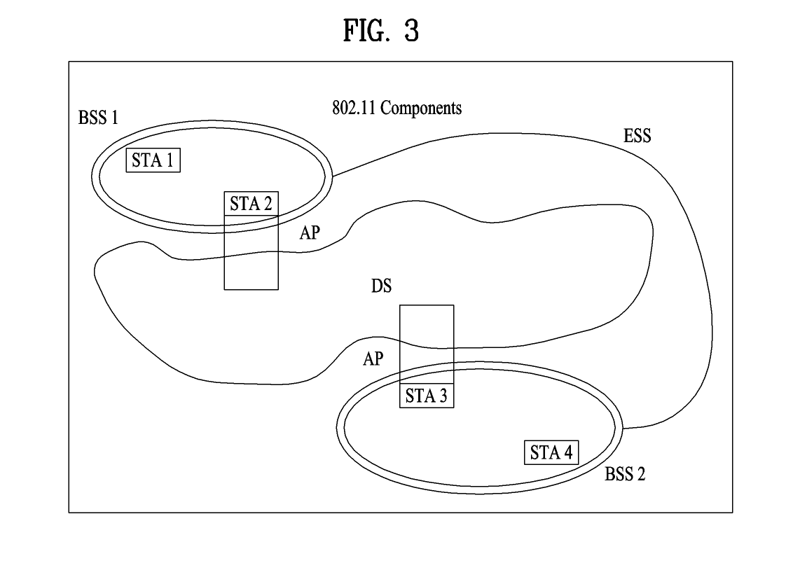

FIG. 3 is a diagram showing still another exemplary structure of an IEEE 802.11 system to which the present invention is applicable. In addition to the structure of FIG. 2, FIG. 3 conceptually shows an extended service set (ESS) for providing wide coverage.

A wireless network having arbitrary size and complexity may be comprised of a DS and BSSs. In the IEEE 802.11 system, such a type of network is referred to an ESS network. The ESS may correspond to a set of BSSs connected to one DS. However, the ESS does not include the DS. The ESS network is characterized in that the ESS network appears as an IBSS network in a logical link control (LLC) layer. STAs included in the ESS may communicate with each other and mobile STAs are movable transparently in LLC from one BSS to another BSS (within the same ESS).

In IEEE 802.11, relative physical locations of the BSSs in FIG. 3 are not assumed and the following forms are all possible. BSSs may partially overlap and this form is generally used to provide continuous coverage. BSSs may not be physically connected and the logical distances between BSSs have no limit. BSSs may be located at the same physical position and this form may be used to provide redundancy. One (or more than one) IBSS or ESS networks may be physically located in the same space as one (or more than one) ESS network. This may correspond to an ESS network form in the case in which an ad-hoc network operates in a location in which an ESS network is present, the case in which IEEE 802.11 networks different organizations physically overlap, or the case in which two or more different access and security policies are necessary in the same location.

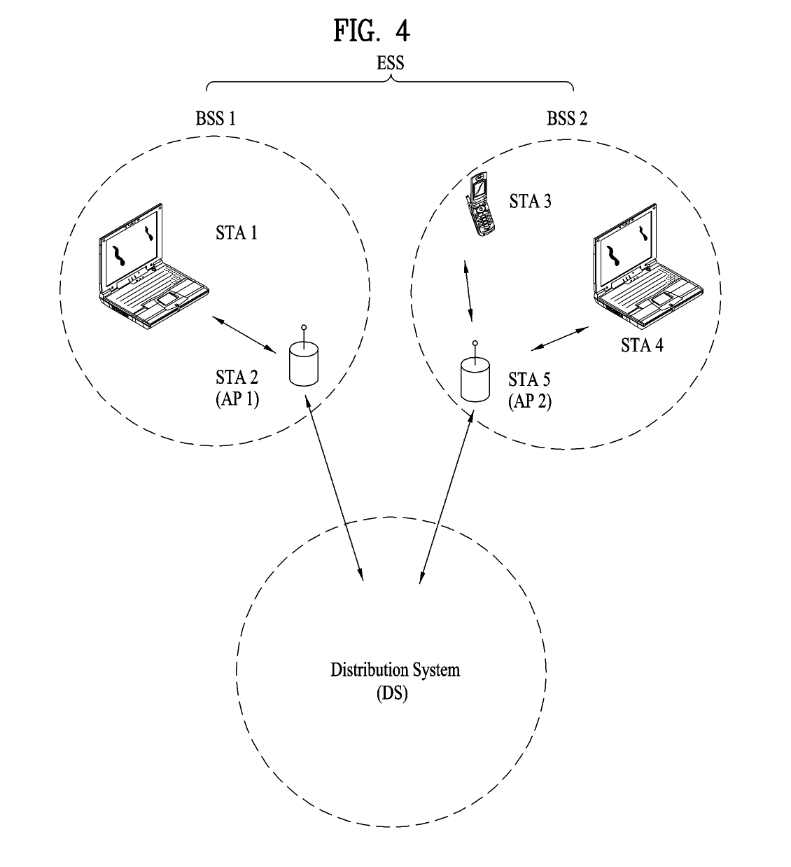

FIG. 4 is a diagram showing an exemplary structure of a WLAN system. In FIG. 4, an example of an infrastructure BSS including a DS is shown.

In the example of FIG. 4, BSS1 and BSS2 constitute an ESS. In the WLAN system, an STA is a device operating according to MAC/PHY regulation of IEEE 802.11. STAs include AP STAs and non-AP STAs. The non-AP STAs correspond to devices, such as mobile phones, handled directly by users. In FIG. 4, STA1, STA3, and STA4 correspond to the non-AP STAs and STA2 and STA5 correspond to AP STAs.

In the following description, the non-AP STA may be referred to as a terminal, a wireless transmit/receive unit (WTRU), a user equipment (UE), a mobile station (MS), a mobile terminal, or a mobile subscriber station (MSS). The AP is a concept corresponding to a base station (BS), a Node-B, an evolved Node-B (eNB), a base transceiver system (BTS), or a femto BS in other wireless communication fields.

Link Setup Process

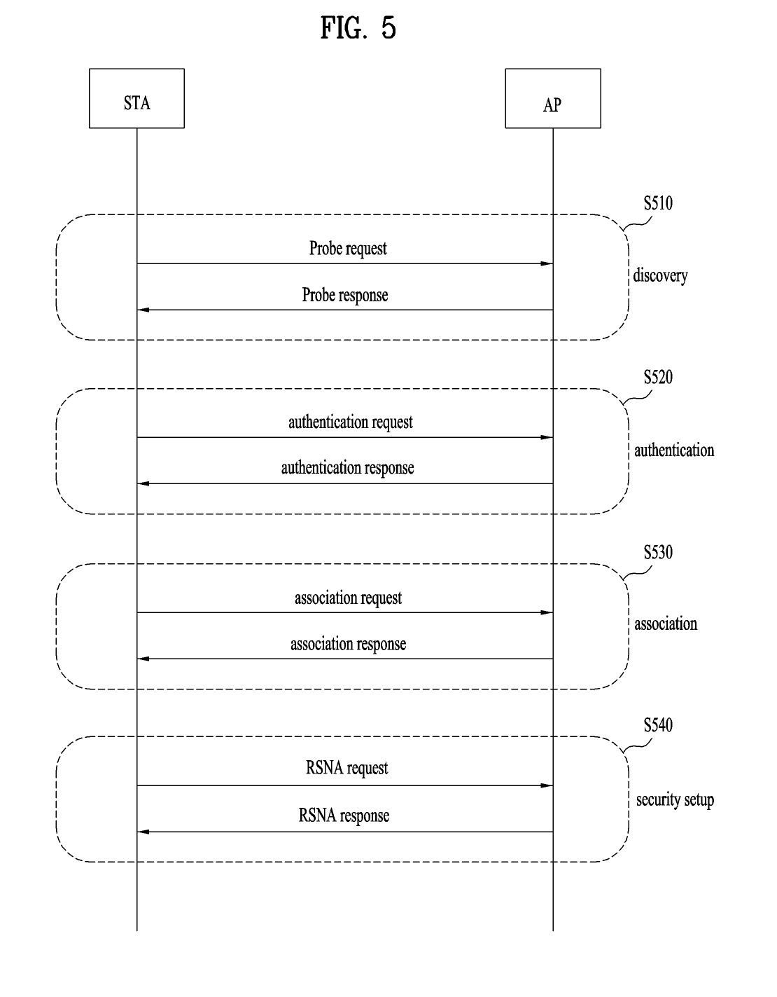

FIG. 5 is a diagram for explaining a general link setup process.

In order to allow an STA to establish link setup on a network and transmit/receive data over the network, the STA should perform processes of network discovery, authentication, association establishment, security setup, etc. The link setup process may also be referred to as a session initiation process or a session setup process. In addition, discovery, authentication, association, and security setup of the link setup process may also be called an association process.

An exemplary link setup process is described with reference to FIG. 5.

In step S510, an STA may perform a network discovery action. The network discovery action may include an STA scanning action. That is, in order to access the network, the STA should search for an available network. The STA needs to identify a compatible network before participating in a wireless network and the process of identifying the network present in a specific area is referred to as scanning.

Scanning is categorized into active scanning and passive scanning.

FIG. 5 exemplarily illustrates a network discovery action including an active scanning process. An STA performing active scanning transmits a probe request frame in order to determine which AP is present in a peripheral region while moving between channels and waits for a response to the probe request frame. A responder transmits a probe response frame in response to the probe request frame to the STA that has transmitted the probe request frame. Here, the responder may be an STA that has finally transmitted a beacon frame in a BSS of the scanned channel. Since an AP transmits a beacon frame in a BSS, the AP is a responder. In an IBSS, since STAs of the IBSS sequentially transmit the beacon frame, a responder is not the same. For example, an STA, that has transmitted the probe request frame at channel #1 and has received the probe response frame at channel #1, stores BSS-related information contained in the received probe response frame, and moves to the next channel (e.g. channel #2). In the same manner, the STA may perform scanning (i.e. probe request/response transmission and reception at Channel #2).

Although not shown in FIG. 5, the scanning action may also be carried out using passive scanning. An STA that performs passive scanning awaits reception of a beacon frame while moving from one channel to another channel. The beacon frame is one of management frames in IEEE 802.11. The beacon frame is periodically transmitted to indicate the presence of a wireless network and allow a scanning STA to search for the wireless network and thus join the wireless network. In a BSS, an AP is configured to periodically transmit the beacon frame and, in an IBSS, STAs in the IBSS are configured to sequentially transmit the beacon frame. Upon receipt of the beacon frame, the scanning STA stores BSS-related information contained in the beacon frame and records beacon frame information on each channel while moving to another channel. Upon receiving the beacon frame, the STA may store BSS-related information contained in the received beacon frame, move to the next channel, and perform scanning on the next channel using the same method.

Active scanning is more advantageous than passive scanning in terms of delay and power consumption.

After discovering the network, the STA may perform an authentication process in step S520. The authentication process may be referred to as a first authentication process in order to clearly distinguish this process from the security setup process of step S540.

The authentication process includes a process in which an STA transmits an authentication request frame to an AP and the AP transmits an authentication response frame to the STA in response to the authentication request frame. The authentication frame used for authentication request/response corresponds to a management frame.

The authentication frame may include information about an authentication algorithm number, an authentication transaction sequence number, a state code, a challenge text, a robust security network (RSN), a finite cyclic group (FCG), etc. The above-mentioned information contained in the authentication frame may correspond to some parts of information capable of being contained in the authentication request/response frame and may be replaced with other information or include additional information.

The STA may transmit the authentication request frame to the AP. The AP may determine whether to permit authentication for the corresponding STA based on the information contained in the received authentication request frame. The AP may provide an authentication processing result to the STA through the authentication response frame.

After the STA has been successfully authenticated, an association process may be carried out in step S530. The association process includes a process in which the STA transmits an association request frame to the AP and the AP transmits an association response frame to the STA in response to the association request frame.

For example, the association request frame may include information associated with various capabilities, a beacon listen interval, a service set identifier (SSID), supported rates, supported channels, an RSN, a mobility domain, supported operating classes, a traffic indication map (TIM) broadcast request, interworking service capability, etc.

For example, the association response frame may include information associated with various capabilities, a status code, an association ID (AID), supported rates, an enhanced distributed channel access (EDCA) parameter set, a received channel power indicator (RCPI), a received signal to noise indicator (RSNI), a mobility domain, a timeout interval (association comeback time), an overlapping BSS scan parameter, a TIM broadcast response, a quality of service (QoS) map, etc.

The above-mentioned information may correspond to some parts of information capable of being contained in the association request/response frame and may be replaced with other information or include additional information.

After the STA has been successfully associated with the network, a security setup process may be performed in step S540. The security setup process of step S540 may be referred to as an authentication process based on robust security network association (RSNA) request/response. The authentication process of step S520 may be referred to as a first authentication process and the security setup process of step S540 may also be simply referred to as an authentication process.

The security setup process of step S540 may include a private key setup process through 4-way handshaking based on, for example, an extensible authentication protocol over LAN (EAPOL) frame. In addition, the security setup process may also be performed according to other security schemes not defined in IEEE 802.11 standards.

WLAN Evolution

To overcome limitations of communication speed in a WLAN, IEEE 802.11n has recently been established as a communication standard. IEEE 802.11n aims to increase network speed and reliability and extend wireless network coverage. More specifically, IEEE 802.11n supports a high throughput (HT) of 540 Mbps or more. To minimize transmission errors and optimize data rate, IEEE 802.11n is based on MIMO using a plurality of antennas at each of a transmitter and a receiver.

With widespread supply of a WLAN and diversified applications using the WLAN, the necessity of a new WLAN system for supporting a higher processing rate than a data processing rate supported by IEEE 802.11n has recently emerged. A next-generation WLAN system supporting very high throughput (VHT) is one of IEEE 802.11 WLAN systems which have been recently proposed to support a data processing rate of 1 Gbps or more in a MAC service access point (SAP), as the next version (e.g. IEEE 802.11ac) of an IEEE 802.11n WLAN system.

To efficiently utilize a radio frequency (RF) channel, the next-generation WLAN system supports a multiuser (MU)-MIMO transmission scheme in which a plurality of STAs simultaneously accesses a channel. In accordance with the MU-MIMO transmission scheme, an AP may simultaneously transmit packets to at least one MIMO-paired STA.

In addition, support of WLAN system operations in whitespace (WS) has been discussed. For example, technology for introducing the WLAN system in TV WS such as an idle frequency band (e.g. 54 to 698 MHz band) due to transition to digital TVs from analog TVs has been discussed under the IEEE 802.11af standard. However, this is for illustrative purposes only, and the WS may be a licensed band capable of being primarily used only by a licensed user. The licensed user is a user who has authority to use the licensed band and may also be referred to as a licensed device, a primary user, an incumbent user, etc.

For example, an AP and/or STA operating in WS should provide a function for protecting the licensed user. As an example, assuming that the licensed user such as a microphone has already used a specific WS channel which is a frequency band divided by regulations so as to include a specific bandwidth in the WS band, the AP and/or STA cannot use the frequency band corresponding to the corresponding WS channel in order to protect the licensed user. In addition, the AP and/or STA should stop using the corresponding frequency band under the condition that the licensed user uses a frequency band used for transmission and/or reception of a current frame.

Therefore, the AP and/or STA needs to determine whether a specific frequency band of a WS band can be used, in other words, whether a licensed user is present in the frequency band. A scheme for determining whether a licensed user is present in a specific frequency band is referred to as spectrum sensing. An energy detection scheme, a signature detection scheme, etc. are used as the spectrum sensing mechanism. The AP and/or STA may determine that the frequency band is being used by a licensed user if the intensity of a received signal exceeds a predetermined value or if a DTV preamble is detected.

Machine-to-machine (M2M) communication technology has been discussed as next generation communication technology. Technical standard for supporting M2M communication has been developed as IEEE 802.11ah in an IEEE 802.11 WLAN system. M2M communication refers to a communication scheme including one or more machines or may also be called machine type communication (MTC) or machine-to-machine communication. In this case, the machine refers to an entity that does not require direct manipulation or intervention of a user. For example, not only a meter or vending machine including a radio communication module but also a user equipment (UE) such as a smartphone capable of performing communication by automatically accessing a network without user manipulation/intervention may be machines. M2M communication may include device-to-device (D2D) communication and communication between a device and an application server. As exemplary communication between a device and an application server, communication between a vending machine and an application server, communication between a point of sale (POS) device and an application server, and communication between an electric meter, a gas meter, or a water meter and an application server. M2M communication-based applications may include security, transportation, healthcare, etc. In the case of considering the above-mentioned application examples, M2M communication has to support occasional transmission/reception of a small amount of data at low speed under an environment including a large number of devices.

More specifically, M2M communication should support a large number of STAs. Although a currently defined WLAN system assumes that one AP is associated with a maximum of 2007 STAs, methods for supporting other cases in which more STAs (e.g. about 6000 STAs) than 2007 STAs are associated with one AP have been discussed in M2M communication. In addition, it is expected that many applications for supporting/requesting a low transfer rate are present in M2M communication. In order to smoothly support these requirements, an STA in the WLAN system may recognize the presence or absence of data to be transmitted thereto based on a TIM element and methods for reducing the bitmap size of the TIM have been discussed. In addition, it is expected that much traffic having a very long transmission/reception interval is present in M2M communication. For example, a very small amount of data such as electric/gas/water metering needs to be transmitted and received at long intervals (e.g. every month). Accordingly, although the number of STAs associated with one AP increases in the WLAN system, methods for efficiently supporting the case in which there are a very small number of STAs each including a data frame to be received from the AP during one beacon period has been discussed.

As described above, WLAN technology is rapidly developing and not only the above-mentioned exemplary technologies but also other technologies including direct link setup, improvement of media streaming throughput, support of high-speed and/or large-scale initial session setup, and support of extended bandwidth and operating frequency are being developed.

Medium Access Mechanism

In a WLAN system based on IEEE 802.11, a basic access mechanism of medium access control (MAC) is a carrier sense multiple access with collision avoidance (CSMA/CA) mechanism. The CSMA/CA mechanism is also referred to as a distributed coordination function (DCF) of the IEEE 802.11 MAC and basically adopts a “listen before talk” access mechanism. In this type of access mechanism, an AP and/or an STA may sense a wireless channel or a medium during a predetermined time duration (e.g. DCF interframe space (DIFS) before starting transmission. As a result of sensing, if it is determined that the medium is in an idle status, the AP and/or the STA starts frame transmission using the medium. Meanwhile, if it is sensed that the medium is in an occupied state, the AP and/or the STA does not start its transmission and may attempt to perform frame transmission after setting and waiting for a delay duration (e.g. a random backoff period) for medium access. Since it is expected that multiple STAs attempt to perform frame transmission after waiting for different time durations by applying the random backoff period, collision can be minimized

An IEEE 802.11 MAC protocol provides a hybrid coordination function (HCF) based on the DCF and a point coordination function (PCF). The PCF refers to a scheme of performing periodic polling by using a polling-based synchronous access method so that all reception APs and/or STAs can receive a data frame. The HCF includes enhanced distributed channel access (EDCA) and HCF controlled channel access (HCCA). EDCA is a contention based access scheme used by a provider to provide a data frame to a plurality of users. HCCA uses a contention-free based channel access scheme employing a polling mechanism. The HCF includes a medium access mechanism for improving QoS of a WLAN and QoS data may be transmitted in both a contention period (CP) and a contention-free period (CFP).

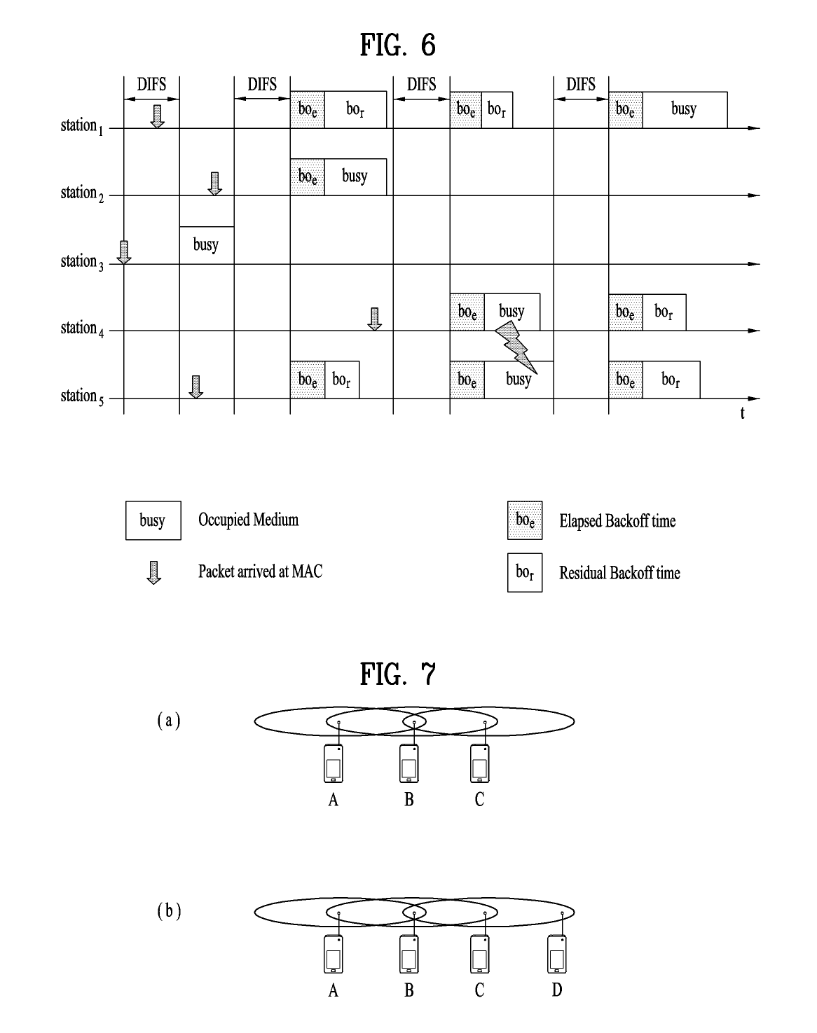

FIG. 6 is a diagram for explaining a backoff process.

Operations based on a random backoff period will now be described with reference to FIG. 6. If a medium of an occupy or busy state transitions to an idle state, several STAs may attempt to transmit data (or frames). As a method for minimizing collision, each STA may select a random backoff count, wait for a slot time corresponding to the selected backoff count, and then attempt to start data or frame transmission. The random backoff count may be a pseudo-random integer and may be set to one of 0 to CW values. In this case, CW is a contention window parameter value. Although CWmin is given as an initial value of the CW parameter, the initial value may be doubled in case of transmission failure (e.g. in the case in which ACK for the transmission frame is not received). If the CW parameter value reaches CWmax, the STAs may attempt to perform data transmission while CWmax is maintained until data transmission is successful. If data has been successfully transmitted, the CW parameter value is reset to CWmin. Desirably, CW, CWmin, and CWmax are set to 2n-1 (where n=0, 1, 2, . . . ).

If the random backoff process is started, the STA continuously monitors the medium while counting down the backoff slot in response to the determined backoff count value. If the medium is monitored as the occupied state, the countdown stops and waits for a predetermined time. If the medium is in the idle status, the remaining countdown restarts.

As shown in the example of FIG. 6, if a packet to be transmitted to MAC of STA3 arrives at STA3, STA3 may confirm that the medium is in the idle state during a DIFS and directly start frame transmission. In the meantime, the remaining STAs monitor whether the medium is in the busy state and wait for a predetermined time. During the predetermined time, data to be transmitted may occur in each of STA1, STA2, and STA5. If it is monitored that the medium is in the idle state, each STA waits for the DIFS time and then may perform countdown of the backoff slot in response to a random backoff count value selected by each STA. The example of FIG. 6 shows that STA2 selects the lowest backoff count value and STA1 selects the highest backoff count value. That is, after STA2 finishes backoff counting, the residual backoff time of STA5 at a frame transmission start time is shorter than the residual backoff time of STA1. Each of STA1 and STA5 temporarily stops countdown while STA2 occupies the medium, and waits for a predetermined time. If occupation of STA2 is finished and the medium re-enters the idle state, each of STA1 and STA5 waits for a predetermined time DIFS and restarts backoff counting. That is, after counting down the remaining backoff time corresponding to the residual backoff time, each of STA1 and STA5 may start frame transmission. Since the residual backoff time of STA5 is shorter than that of STA1, STA5 starts frame transmission. Meanwhile, data to be transmitted may occur even in STA4 while STA2 occupies the medium. In this case, if the medium is in the idle state, STA4 may wait for the DIFS time, perform countdown in response to the random backoff count value selected thereby, and then start frame transmission. FIG. 6 exemplarily shows the case in which the residual backoff time of STA5 is identical to the random backoff count value of STA4 by chance. In this case, collision may occur between STA4 and STA5. Then, each of STA4 and STA5 does not receive ACK, resulting in occurrence of data transmission failure. In this case, each of STA4 and STA5 may increase the CW value by two times, select a random backoff count value, and then perform countdown. Meanwhile, STA1 waits for a predetermined time while the medium is in the occupied state due to transmission of STA4 and STA5. If the medium is in the idle state, STA1 may wait for the DIFS time and then start frame transmission after lapse of the residual backoff time.

STA Sensing Operation

As described above, the CSMA/CA mechanism includes not only a physical carrier sensing mechanism in which the AP and/or an STA directly senses a medium but also a virtual carrier sensing mechanism. The virtual carrier sensing mechanism can solve some problems such as a hidden node problem encountered in medium access. For virtual carrier sensing, MAC of the WLAN system may use a network allocation vector (NAV). The NAV is a value used to indicate a time remaining until an AP and/or an STA which is currently using the medium or has authority to use the medium enters an available state to another AP and/or STA. Accordingly, a value set to the NAV corresponds to a reserved time in which the medium will be used by an AP and/or STA configured to transmit a corresponding frame. An STA receiving the NAV value is not allowed to perform medium access during the corresponding reserved time. For example, NAV may be set according to the value of a ‘duration’ field of a MAC header of a frame.

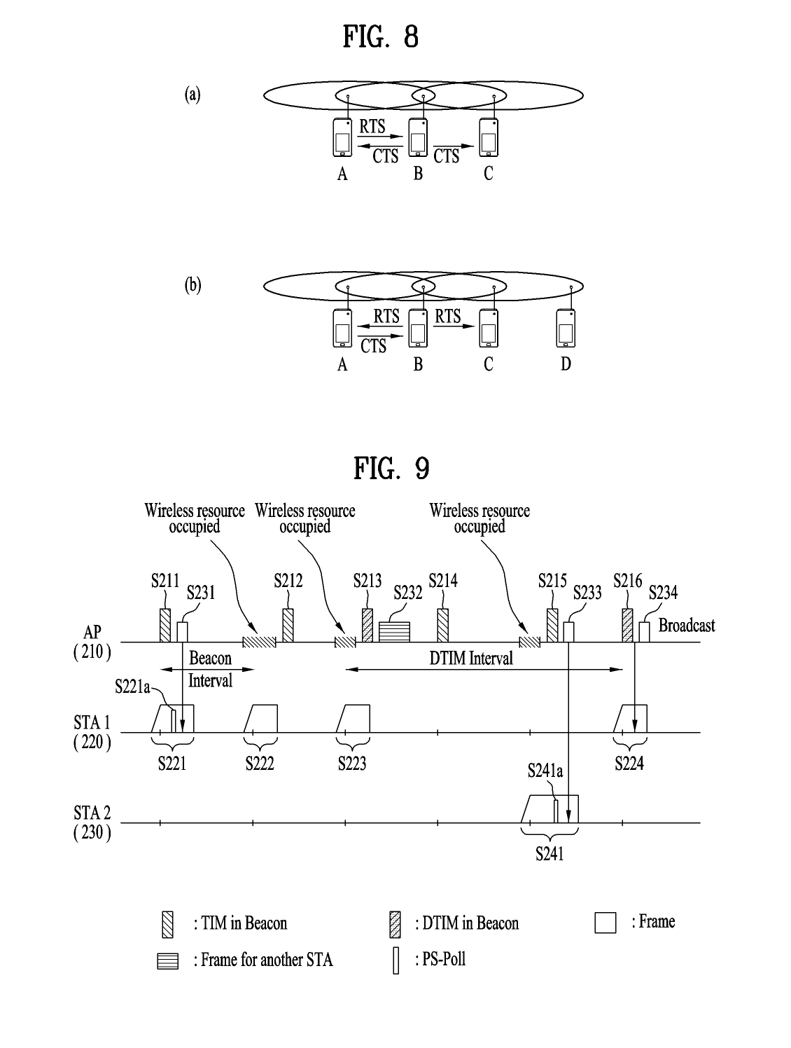

A robust collision detection mechanism has been proposed to reduce the probability of collision. This will be described with reference to FIGS. 7 and 8. Although an actual carrier sensing range is different from a transmission range, it is assumed that the actual carrier sensing range is identical to the transmission range for convenience of description.

FIG. 7 is a diagram for explaining a hidden node and an exposed node.

FIG. 7(a) exemplarily shows a hidden node. In FIG. 7(a), STA A communicates with STA B, and STA C has information to be transmitted. Specifically, STA C may determine that a medium is in an idle state when performing carrier sensing before transmitting data to STA B, although STA A is transmitting information to STA B. This is because transmission of STA A (i.e. occupation of the medium) may not be detected at the location of STA C. In this case, STA B simultaneously receives information of STA A and information of STA C, resulting in occurrence of collision. Here, STA A may be considered a hidden node of STA C.

FIG. 7(b) exemplarily shows an exposed node. In FIG. 7(b), in a situation in which STA B transmits data to STA A, STA C has information to be transmitted to STA D. If STA C performs carrier sensing, it is determined that a medium is occupied due to transmission of STA B. Therefore, although STA C has information to be transmitted to STA D, since the medium-occupied state is sensed, STA C should wait for a predetermined time until the medium is in the idle state. However, since STA A is actually located out of the transmission range of STA C, transmission from STA C may not collide with transmission from STA B from the viewpoint of STA A, so that STA C unnecessarily enters a standby state until STA B stops transmission. Here, STA C is referred to as an exposed node of STA B.

FIG. 8 is a diagram for explaining request to send (RTS) and clear to send (CTS).

To efficiently utilize a collision avoidance mechanism under the above-mentioned situation of FIG. 7, it is possible to use a short signaling packet such as RTS and CTS. RTS/CTS between two STAs may be overheard by peripheral STA(s), so that the peripheral STA(s) may consider whether information is transmitted between the two STAs. For example, if an STA to be used for data transmission transmits an RTS frame to an STA receiving data, the STA receiving data may inform peripheral STAs that itself will receive data by transmitting a CTS frame to the peripheral STAs.

FIG. 8(a) exemplarily shows a method for solving problems of a hidden node. In FIG. 8(a), it is assumed that both STA A and STA C are ready to transmit data to STA B. If STA A transmits RTS to STA B, STA B transmits CTS to each of STA A and STA C located in the vicinity of the STA B. As a result, STA C waits for a predetermined time until STA A and STA B stop data transmission, thereby avoiding collision.

FIG. 8(b) exemplarily shows a method for solving problems of an exposed node. STA C performs overhearing of RTS/CTS transmission between STA A and STA B, so that STA C may determine that no collision will occur although STA C transmits data to another STA (e.g. STA D). That is, STA B transmits RTS to all peripheral STAs and only STA A having data to be actually transmitted may transmit CTS. STA C receives only the RTS and does not receive the CTS of STA A, so that it can be recognized that STA A is located outside of the carrier sensing range of STA C.

Power Management

As described above, the WLAN system needs to perform channel sensing before an STA performs data transmission/reception. The operation of always sensing the channel causes persistent power consumption of the STA. Power consumption in a reception state is not greatly different from that in a transmission state. Continuous maintenance of the reception state may cause large load to a power-limited STA (i.e. an STA operated by a battery). Therefore, if an STA maintains a reception standby mode so as to persistently sense a channel, power is inefficiently consumed without special advantages in terms of WLAN throughput. In order to solve the above-mentioned problem, the WLAN system supports a power management (PM) mode of the STA.

The PM mode of the STA is classified into an active mode and a power save (PS) mode. The STA basically operates in the active mode. The STA operating in the active mode maintains an awake state. In the awake state, the STA may perform a normal operation such as frame transmission/reception or channel scanning On the other hand, the STA operating in the PS mode is configured to switch between a sleep state and an awake state. In the sleep state, the STA operates with minimum power and performs neither frame transmission/reception nor channel scanning

Since power consumption is reduced in proportion to a specific time in which the STA stays in the sleep state, an operation time of the STA is increased. However, it is impossible to transmit or receive a frame in the sleep state so that the STA cannot always operate for a long period of time. If there is a frame to be transmitted to an AP, the STA operating in the sleep state is switched to the awake state to transmit/receive the frame. On the other hand, if the AP has a frame to be transmitted to the STA, the sleep-state STA is unable to receive the frame and cannot recognize the presence of a frame to be received. Accordingly, the STA may need to switch to the awake state according to a specific period in order to recognize the presence or absence of a frame to be transmitted thereto (or in order to receive the frame if the AP has the frame to be transmitted thereto).

FIG. 9 is a diagram for explaining a PM operation.

Referring to FIG. 9, an AP 210 transmits a beacon frame to STAs present in a BSS at intervals of a predetermined time period (S211, S212, S213, S214, S215, and S216). The beacon frame includes a TIM information element. The TIM information element includes buffered traffic regarding STAs associated with the AP 210 and includes information indicating that a frame is to be transmitted. The TIM information element includes a TIM for indicating a unicast frame and a delivery traffic indication map (DTIM) for indicating a multicast or broadcast frame.

The AP 210 may transmit a DTIM once whenever the beacon frame is transmitted three times. Each of STA1 220 and STA2 222 operate in a PS mode. Each of STA1 220 and STA2 222 is switched from a sleep state to an awake state every wakeup interval of a predetermined period such that STA1 220 and STA2 222 may be configured to receive the TIM information element transmitted by the AP 210. Each STA may calculate a switching start time at which each STA may start switching to the awake state based on its own local clock. In FIG. 9, it is assumed that a clock of the STA is identical to a clock of the AP.

For example, the predetermined wakeup interval may be configured in such a manner that STA1 220 can switch to the awake state to receive the TIM element every beacon interval. Accordingly, STA1 220 may switch to the awake state when the AP 210 first transmits the beacon frame (S211). STA1 220 may receive the beacon frame and obtain the TIM information element. If the obtained TIM element indicates the presence of a frame to be transmitted to STA1 220, STA1 220 may transmit a power save-Poll (PS-Poll) frame, which requests the AP 210 to transmit the frame, to the AP 210 (S221a). The AP 210 may transmit the frame to STA1 220 in response to the PS-Poll frame (S231). STA1 220 which has received the frame is re-switched to the sleep state and operates in the sleep state.

When the AP 210 secondly transmits the beacon frame, since a busy medium state in which the medium is accessed by another device is obtained, the AP 210 may not transmit the beacon frame at an accurate beacon interval and may transmit the beacon frame at a delayed time (S212). In this case, although STA1 220 is switched to the awake state in response to the beacon interval, STA1 does not receive the delay-transmitted beacon frame so that it re-enters the sleep state (S222).

When the AP 210 thirdly transmits the beacon frame, the corresponding beacon frame may include a TIM element configured as a DTIM. However, since the busy medium state is given, the AP 210 transmits the beacon frame at a delayed time (S213). STA1 220 is switched to the awake state in response to the beacon interval and may obtain a DTIM through the beacon frame transmitted by the AP 210. It is assumed that the DTIM obtained by STA1 220 does not have a frame to be transmitted to STA1 220 and there is a frame for another STA. In this case, STA1 220 may confirm the absence of a frame to be received in the STA1 220 and re-enters the sleep state so that the STA1 220 may operate in the sleep state. After transmitting the beacon frame, the AP 210 transmits the frame to the corresponding STA (S232).

The AP 210 fourthly transmits the beacon frame (S214). However, since it was impossible for STA1 220 to obtain information regarding the presence of buffered traffic associated therewith through previous double reception of a TIM element, STA1 220 may adjust the wakeup interval for receiving the TIM element. Alternatively, provided that signaling information for coordination of the wakeup interval value of STA1 220 is contained in the beacon frame transmitted by the AP 210, the wakeup interval value of the STA1 220 may be adjusted. In this example, STA1 220, which has been switched to receive a TIM element every beacon interval, may be configured to be switched to another operation state in which STA1 220 awakes from the sleep state once every three beacon intervals. Therefore, when the AP 210 transmits a fourth beacon frame (S214) and transmits a fifth beacon frame (S215), STA1 220 maintains the sleep state such that it cannot obtain the corresponding TIM element.

When the AP 210 sixthly transmits the beacon frame (S216), STA1 220 is switched to the awake state and operates in the awake state, so that the STA1 220 may obtain the TIM element contained in the beacon frame (S224). The TIM element is a DTIM indicating the presence of a broadcast frame. Accordingly, STA1 220 does not transmit the PS-Poll frame to the AP 210 and may receive the broadcast frame transmitted by the AP 210 (S234). In the meantime, the wakeup interval configured for STA2 230 may be longer than the wakeup interval of STA1 220. Accordingly, STA2 230 may enter the awake state at a specific time (S215) where the AP 210 fifthly transmits the beacon frame and receives the TIM element (S241). STA2 230 may recognize the presence of a frame to be transmitted thereto through the TIM element and transmit the PS-Poll frame to the AP 210 to request frame transmission (S241a). The AP 210 may transmit the frame to STA2 230 in response to the PS-Poll frame (S233).

In order to manage a PS mode shown in FIG. 9, the TIM element may include either a TIM indicating the presence or absence of a frame to be transmitted to the STA or include a DTIM indicating the presence or absence of a broadcast/multicast frame. The DTIM may be implemented through field setting of the TIM element.

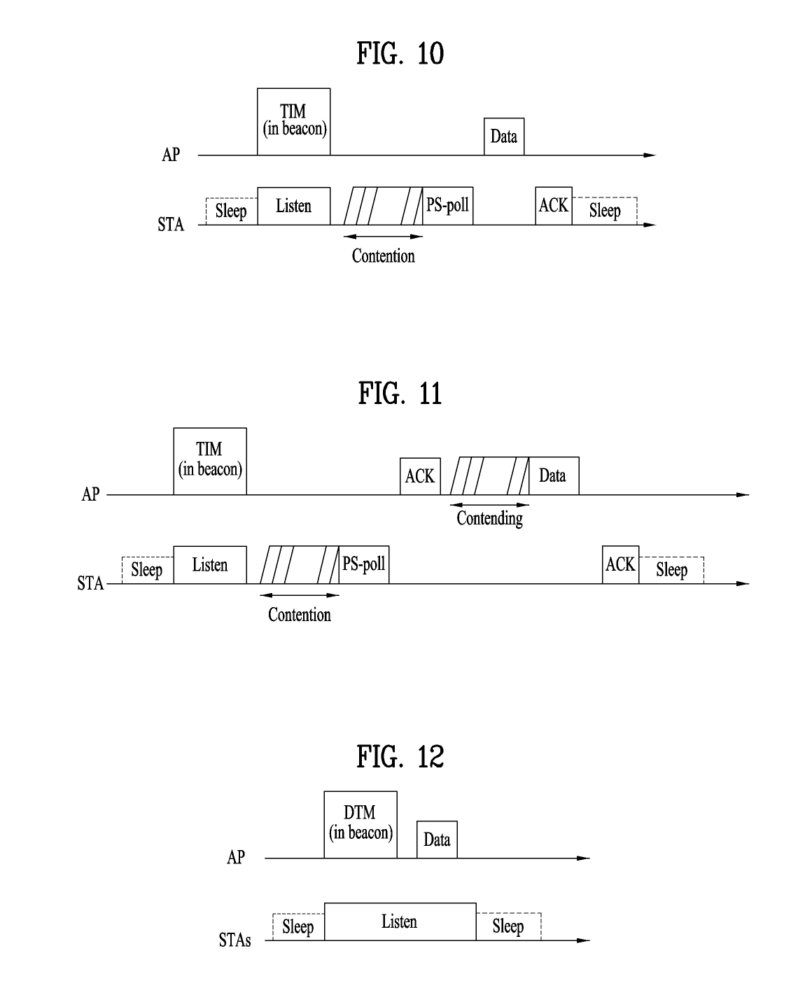

FIGS. 10 to 12 are diagrams for explaining detailed operations of an STA that has received a TIM.

Referring to FIG. 10, an STA is switched from a sleep state to an awake state so as to receive a beacon frame including a TIM from an AP. The STA may recognize the presence of buffered traffic to be transmitted thereto by interpreting the received TIM element. After contending with other STAs to access a medium for PS-Poll frame transmission, the STA may transmit the PS-Poll frame for requesting data frame transmission to the AP. Upon receiving the PS-Poll frame transmitted by the STA, the AP may transmit the frame to the STA. The STA may receive a data frame and then transmit an ACK frame to the AP in response to the received data frame. Thereafter, the STA may re-enter the sleep state.

As illustrated in FIG. 10, the AP may operate according to an immediate response scheme in which the AP receives the PS-Poll frame from the STA and transmits the data frame after a predetermined time (e.g. a short interframe space (SIFS)). Meanwhile, if the AP does not prepare a data frame to be transmitted to the STA during the SIFS time after receiving the PS-Poll frame, the AP may operate according to a deferred response scheme and this will be described with reference to FIG. 11.

The STA operations of FIG. 11 in which an STA is switched from a sleep state to an awake state, receives a TIM from an AP, and transmits a PS-Poll frame to the AP through contention are identical to those of FIG. 10. Even upon receiving the PS-Poll frame, if the AP does not prepare a data frame during an SIFS time, the AP may transmit an ACK frame to the STA instead of transmitting the data frame. If the data frame is prepared after transmission of the ACK frame, the AP may transmit the data frame to the STA after completion of contention. The STA may transmit the ACK frame indicating that the data frame has successfully been received to the AP and transition to the sleep state.

FIG. 12 illustrates an exemplary case in which an AP transmits a DTIM. STAs may be switched from the sleep state to the awake state so as to receive a beacon frame including a DTIM element from the AP. The STAs may recognize that a multicast/broadcast frame will be transmitted through the received DTIM. After transmission of the beacon frame including the DTIM, the AP may directly transmit data (i.e. the multicast/broadcast frame) without transmitting/receiving a PS-Poll frame. While the STAs continuously maintains the awake state after reception of the beacon frame including the DTIM, the STAs may receive data and then switch to the sleep state after completion of data reception.

APSD Mechanism

An AP supporting automatic power save delivery (APSD) may signal that APSD is supported through an APSD subfield in a capability information field of a beacon frame, a probe response frame, or an association response frame (or reassociation response frame). An STA capable of supporting APSD may indicate whether the operation mode is an active mode or a PS mode, using the Power Management field in the FC field of a frame.

APSD is a mechanism for delivering downlink data and a bufferable management frame to an STA operating in the PS mode. The Power Management bit of the FC field of a frame transmitted by an STA which is using APSD in the PS mode is set to 1. Thereby, buffering in the AP may be triggered.

APSD defines two delivery mechanisms, i.e., unscheduled-APSD (U-APSD) and scheduled-APSD (S-APSD). The STA may employ U-APSD to allow a part or an entirety of a bufferable unit (BU) to be delivered during an unscheduled service period (SP). The STA may employ S-APSD to allow a part or an entirety of the BU to be delivered during a scheduled SP.

According to the U-APSD mechanism, in order to use the U-APSD SP, an STA may inform an AP of a requested transmission duration, and the AP may transmit a frame to the STA during the SP. According to the U-APSD mechanism, the STA may receive multiple PSDUs from the AP at the same time within its own SP.

The STA may recognize through the TIM element of the beacon that the AP has data to transmit to the STA. Thereafter, the STA may transmit a trigger frame to the AP at a desired time, thereby informing the AP that the SP of the STA has started and requesting that the AP transmit the data. The AP may transmit ACK to the STA in response to the trigger frame. Thereafter, the AP may transmit RTS to the STA through contention, receive a CTS frame from the STA, and then transmit the data to the STA. Herein, the data transmitted from the AP may include at least one data frame. When the AP transmits the last data frame with the EOSP (End Of Service Period) field of the data frame set to 1, the STA may recognize this and end the SP. Thereby, the STA may transmit ACK indicating successful reception of the data to the AP. According to the U-APSD mechanism described above, the STA is allowed to start its own SP and receive data when it desires. Since the STA is capable of receiving multiple data frames within one SP, data may be efficiently received.

An STA using the U-APSD mechanism may fail to receive a frame transmitted from the AP during the SP due to interference. The AP may fail to sense such interference, but may determine that the STA has not correctly received the frame. The STA may inform the AP of a requested transmission duration using the U-APSD coexistence capability and use the requested transmission duration as an SP for U-APSD. The AP may transmit a frame during the SP, thereby enhancing the possibility that the STA will receive a frame while the STA is subjected to interference. In addition, U-APSD may lower the possibility that the STA will fail to successfully receive a frame transmitted from the AP during the SP.

The STA may transmit, to the AP, an Add Traffic Stream (ADDTS) request frame containing a U-APSD coexistence element. The U-APSD coexistence element may include information about a requested SP.

The AP may perform processing in relation to the requested SP, and transmit an ADDTS response frame in response to the ADDTS request frame. The ADDTS request frame may contain a status code. The status code may indicate response information about the requested SP. The status code may indicate whether or not the requested SP is accepted. If the requested SP is rejected, the status code may further indicate the reason for rejection.

If the requested SP is accepted by the AP, the AP may transmit a frame to the STA during the SP. The duration of the SP may be designated by the U-APSD coexistence element contained in the ADDTS request frame. The start time of the SP may be a time at which the AP normally receives a trigger frame transmitted from the STA.

When the U-APSD SP expires, the STA may enter the sleep state (or doze state).

PPDU Frame Format

A PPDU (Physical Layer Convergence Protocol (PLCP) Packet Data Unit) frame format may include fields such as STF (Short Training Field), LTF (Long Training Field), SIG (SIGNAL) and Data. The most basic PPDU frame format (e.g., a non-High Throughput (HT) PPDU frame format) may consist of fields of L-STF (Legacy-STF), L-LTF (Legacy-LTF), SIG and Data. In addition, depending on the type of a PPDU frame format (e.g., an HT-mixed format PPDU, an HT-greenfield format PPDU, a VHT (Very High Throughput) PPDU, etc.), additional (or other types of) fields STF, LTF, and SIG may be included between the fields SIG and Data.

STF represents a signal for signal detection, automatic gain control (AGC), diversity selection, precise time synchronization, and the like, and LTF represents a signal for channel estimation, frequency error estimation, and the like. STF and LTF may be together referred to as a PLCP preamble. The PLCP preamble may represent a signal for channel estimation and synchronization of an OFDM physical layer.

The field SIG may include fields such as RATE and LENGTH. The field RATE may contain information about data demodulation and coding rate. The field LENGTH may contain information about the length of data. Additionally, the field SIG may include a parity bit and an SIG TAIL bit.

The field Data may include a field SERVICE, PSDU (PLCP Service Data Unit), and a PPDU TAIL bit. When necessary, the field may also include a padding bit. Some bits of the field SERVICE may be used to synchronize a descrambler in a receiver. PSDU corresponds to a MAC PDU defined on the MAC layer, and may contain data produced/used on a higher layer. The PPDU TAIL bit may be used to return the state of an encoder to 0. The padding bit may be used to adjust the length of the field Data to a predetermined unit.

MAC PDU is defined according to various MAC frame formats, and a basic MAC frame includes a MAC header, a frame body, and an FCS (Frame Check Sequence). The MAC frame may be configured by the MAC PDU and transmitted/received through a PSDU of the data part of a PPDU frame format.

A null-data packet (NDP) frame format represents a frame format that does not include a data packet. That is, an NDP frame includes the PLCP header part (i.e., an STF, an LTF and an SIG field) of a typical PPDU format, but does not include the other parts (i.e., the field Data) of the typical PPDU format. The NDP frame may be referred to as a short frame format.

Active polling

An STA allowed to perform active polling may perform polling to the AP immediately after waking up. That is, an STA allowed to perform active polling may perform the polling operation (e.g., transmission of a PS-Poll frame) without listening for a beacon after waking up. Such STA may be referred to as a non-TIM STA in the sense that the STA is allowed to perform polling without checking the TIM element contained in the beacon frame. If there is data to be transmitted to an STA performing polling according to the TIM element contained in the beacon frame, the STA may be referred to as a TIM STA.

Active polling may be divided into scheduled active polling and unscheduled active polling.

In scheduled active polling, the AP may schedule the wake-up time of the STA, and the STA may wake up at the scheduled time and perform an operation for UL/DL transmission. The STA need not track a beacon.

In unscheduled active polling, the AP may allow an STA or STA group to transmit a UL frame at a time when the STA or STA group wakes up, and the STA need not track a beacon.

An active polling STA that does not track the beacon may miss information updated through the beacon, time stamp information, and the like. Accordingly, upon waking up, the active polling STA may request that the AP provide the aforementioned information. Then, the AP may immediately provide requested information to the STA or send a signal indicating that the STA shall receive the information through the next beacon. To this end, the AP may provide the STA with a timer for reception of the next beacon.

Channel Access by Non-TIM STA

While a TIM STA is defined to wake up at every listen interval to receive a beacon, check the TIM contained in the beacon and operate according to the checked TIM, a non-TIM STA need not wake up at every listen interval to receive a beacon. Accordingly, the non-TIM STA may wake up at any time (e.g., in the middle of a listen interval) to transmit a PS-Poll frame, a trigger frame, a UL data frame, or an RTS frame to the AP to perform data transmission/reception.

If another STA operating as a hidden node of the non-TIM STA is transmitting a frame to the AP when the non-TIM STA transmits the PS-Poll frame, trigger frame, UL data frame, or RTS frame to the AP, collision may occur between the PS-Poll frame, trigger frame, UL data frame, or RTS frame transmitted by the non-TIM STA and the frame transmitted by another STA.

FIG. 13 is a diagram illustrating collision between transmission by a non-TIM STA and transmission by another STA.

In the example of FIG. 13, it is assumed that STA1 is a hidden node for STA2 and STA2 is a hidden node for STA1 and that STA2 is a non-TIM STA. STA1 may acquire a transmission opportunity (TXOP) and access a channel (or a medium) through the process of exchange of RTS and CTS frames. Meanwhile, when STA2 operating in the sleep mode wakes up, STA2 may transmit a PS-Poll frame without receiving a beacon from the AP.

Referring to the figure, when STA2 wakes up, STA2 transmits a PS-Poll frame after a time corresponding to a probe delay (PD) time and a random backoff (RBO) time passes. In the example of FIG. 13, when STA2 is in the sleep state, STA2 cannot receive an RTS/CTS frame communicated between STA1 and the AP. Accordingly, STA2 in the sleep state may not recognize whether STA1 is using the channel (or medium). In addition, as STA2 fails to sense that STA1 serving as a hidden node uses the channel (i.e., transmit a data frame), STA2 determines that the channel is in the idle state and transmits a PS-Poll frame via the backoff process.

If STA2 transmits the PS-Poll frame to an AP while STA1 is transmitting a data frame to the AP, collision may occur between the data frame from STA1 and a PS-Poll from STA2. In this case, the AP may fail to correctly receive the PS-Poll frame from STA2. Thereby, the AP may not transmit an ACK frame or data frame to STA2. As STA2 does not receive the ACK frame for a specific time (e.g., an SIFS) after transmitting the PS-Poll frame, STA2 determines that an error has occurred in frame transmission and attempts to retransmit the PS-Poll frame after an exponential random backoff time.

Even when STA2 attempts to retransmit the PS-Poll frame, STA2 may determine that the medium is in the idle state and perform the backoff process since STA2 cannot sense the hidden node STA1 using the channel. Thereby, collision occurs between the PS-Poll frame retransmitted by STA2 and the data frame transmitted by STA1. As a result, STA2 fails to receive an ACK frame for the PS-Poll frame from the AP. STA2 performs the backoff process for the ERBO time in order to reattempt to transmit the PS-Poll frame. Meanwhile, the AP having received the data frame from STA1 may transmit an ACK frame or block ACK (BA) frame indicating successful reception of the data frame to STA1.

As such, if the non-TIM STA attempts to transmit a PS-Poll frame, trigger frame, UL data frame, or RTS frame without knowing whether the channel is used/occupied, unnecessary power consumption in the non-TIM STA increases and overall network performance is degraded. . Accordingly, it is necessary to prevent this problem.

Improved Channel Access Operation of Non-TIM STA

Hereinafter, methods to improve the channel access scheme of the Non-TIM STA will be discussed.

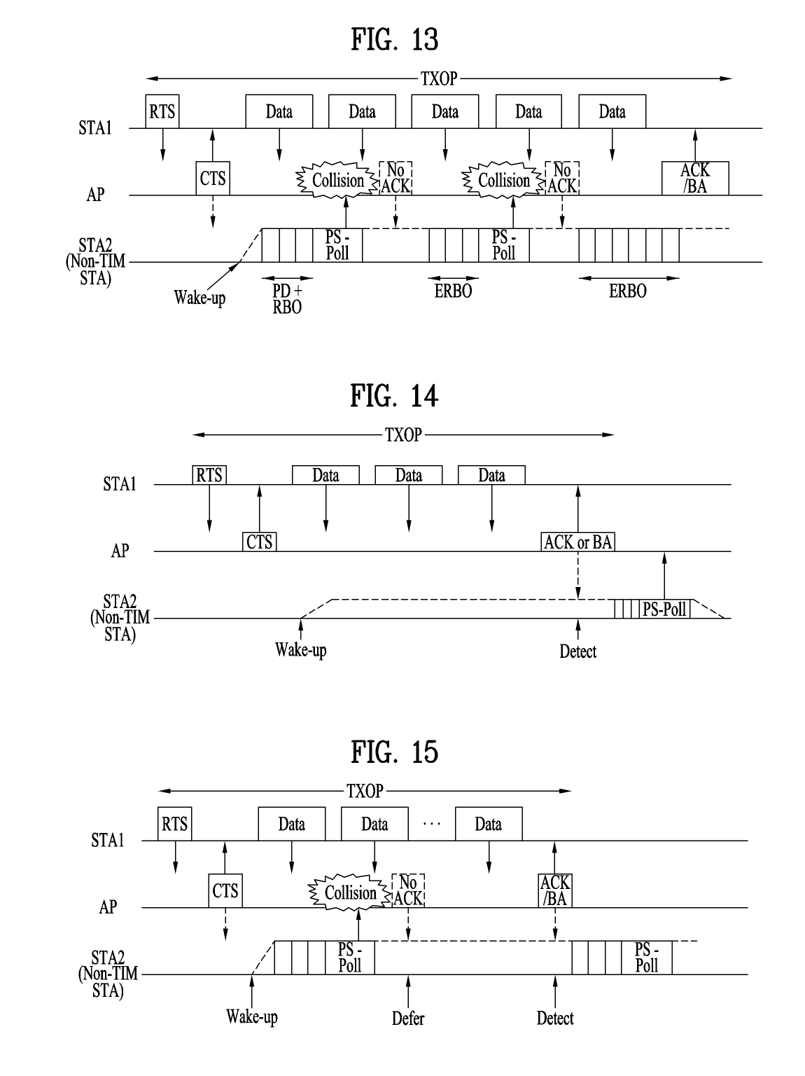

FIG. 14 is a diagram illustrating transmission of a PS-Poll frame by a non-TIM STA according to an embodiment of the present invention.

In the example of FIG. 14, a non-TIM STA waking up from the sleep mode is allowed to transmit a PS-Poll/trigger/data/RTS frame via the backoff process only after performing not only channel sensing but also detection/reception of a frame from another STA.

Herein, if it is determined that the channel is in the idle state, this means that use of the channel by other STAs has not been detected as a result of channel sensing by the non-TIM STA and that a network allocation vector (NAV) for prohibiting/deferring channel access from the non-TIM STA based on the information contained in a frame transmitted from another STA is not set. That is, according to a proposed operation of the non-TIM STA, even if channel access is allowed, the non-TIM STA defers transmission of a PS-Poll/trigger/data/RTS frame until the non-TIM STA receives a frame from another STA, in contrast with the conventionally defined STA operation.

Referring to FIG. 14, STA1 may acquire a TXOP via exchange of RTS/CTS and transmit a data frame to the AP. While STA1 is performing TXOP-related operation, STA2, which is a non-TIM STA, wakes up from the sleep mode and performs channel sensing before attempting to transmit a PS-Poll frame. Since STA1 is a hidden node for STA2 and STA2 is a hidden node for STA1, STA2 cannot recognize that STA1 is using a channel (namely, transmitting a data frame), and thus may determine that the channel is idle.

Herein, if the channel is idle as a result of channel sensing, STA2 is not allowed to immediately transmit the PS-Poll frame, but may wait to receive a frame from another STA. In other words, only if the channel is idle as a result of channel sensing and a frame is received from another STA, may the non-TIM STA waking up from the sleep mode be allowed to attempt channel access according to the EDCA scheme after rechecking if the channel is idle.

Herein, the period for which the non-TIM STA waits to receive a frame from another STA may be limited to a maximum TXOP period (i.e., the maximum value of a TXOP limit (e.g., 8160 ps)). That is, when the channel is idle, an STA waits to receive a frame from another STA for the maximum TXOP period, and then attempts channel access according to the EDCA scheme if the frame is not received within the maximum TXOP period. Thereby, when the channel is actually idle, but it is determined due to an error that no frame is received from another STA, inefficiency of no STA being allowed to use the channel may be lowered.

In the example of FIG. 14, when STA2 detects or overhears an ACK frame or BA frame which the AP transmits to STA1, STA2 may transmit a PS-Poll frame via the backoff process.

The non-TIM STA may wake up and wait, determining that the channel is idle as a result of channel sensing. While waiting, the non-TIM STA may receive a frame from another STA. If the frame contains information (e.g., a duration field) indicating that another STA is occupying the relevant channel, the non-TIM STA may determine that the channel is not idle even after reception the frame is completed. Thereby, the non-TIM STA may perform a corresponding operation (i.e., stopping execution of backoff count while another STA is occupying the channel).

That is, after the non-TIM STA wakes up and determines that the channel is idle, the non-TIM STA is not allowed to immediately perform channel access when reception of a frame from another STA is completed. Rather, the non-TIM STA may recheck if the channel is idle at this time and attempt channel access via the backoff process.

FIG. 15 is a diagram illustrating transmission of a PS-Poll frame by a non-TIM STA according to another embodiment of the present invention.

In the example of FIG. 15, when a non-TIM STA wakes up from the sleep mode, the non-TIM STA senses a channel before transmitting a PS-Poll/trigger/data/RTS frame. Then the non-TIM STA transmits the PS-Poll/trigger/data/RTS frame if the channel is idle. If the non-TIM STA fails to receive a response frame for the transmitted PS-Poll/trigger/data/RTS frame, the non-TIM STA defers retransmission of the PS-Poll/trigger/data/RTS frame, and then transmits the PS-Poll/trigger/data/RTS frame via the backoff process only after detecting/receiving a frame from another STA.

Herein, the period for which the non-TIM STA waits to receive a frame from another STA may be limited to a maximum TXOP period (i.e., the maximum value of a TXOP limit (e.g., 8160 μs)). That is, if the non-TIM STA fails to receive a corresponding response frame (e.g., an ACK, CTS or data frame) after transmitting a PS-Poll/trigger/data/RTS frame, the non-TIM STA waits to receive a frame from another STA for the maximum TXOP period. If the frame is not received for the maximum TXOP period, the non-TIM STA attempts channel access according to the EDCA scheme. Thereby, when the channel is actually idle, but it is determined by an error that no frame is received from another STA, inefficiency of no STA being allowed to use the channel may be lowered

In the example of FIG. 15, STA1 may acquire a TXOP via exchange of RTS/CTS and transmit a data frame to the AP. While STA1 is performing TXOP-related operation, STA2, which is a non-TIM STA, may wake up from the sleep mode and check if the channel is idle for the probe delay (PD). Thereafter, STA2 may perform the backoff process for a random backoff (RBO) time, and then transmit a PS-Poll frame.

If STA2 fails to receive an ACK frame for the transmitted PS-Poll frame after a predetermined time (e.g., SIFS), STA2 does not perform the backoff process for retransmission of the PS-Poll frame, but defers transmission of the PS-Poll frame. Transmission of the PS-Poll frame is deferred until STA2 receives a frame from another STA. In other words, if the channel is idle when the non-TIM STA wakes up from the sleep mode, the non-TIM STA may attempt channel access for the first time. If the first channel access is not successful, the non-TIM STA may be allowed to attempt channel access according to the EDCA scheme for the second time after confirming that the channel is idle only if a frame from another STA is detected/received.

In the example of FIG. 15, if STA2 fails to receive an ACK frame for the PS-Poll frame STA2 has transmitted for the first time after waking up, STA2 may defer retransmission of the PS-Poll frame, and retransmit the PS-Poll frame via the backoff process after detecting an ACK or BA frame from the AP.

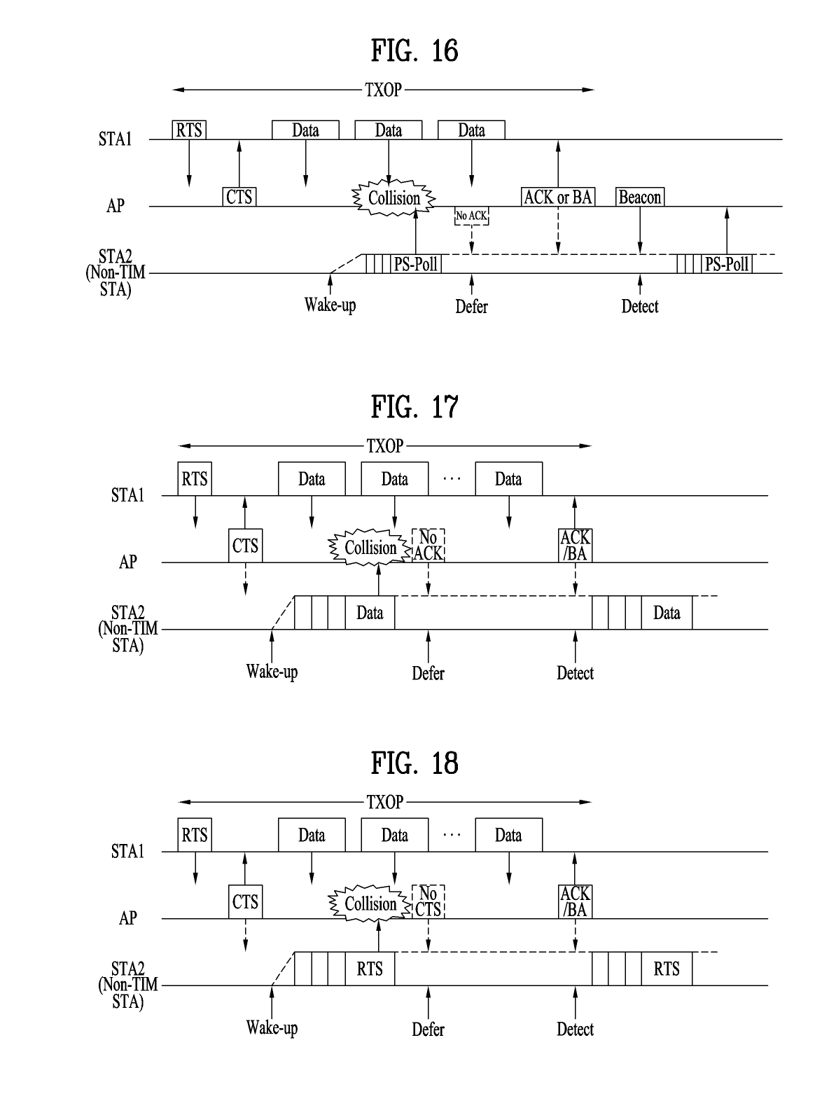

FIG. 16 is a diagram illustrating transmission of a PS-Poll frame by a non-TIM STA according to another embodiment of the present invention.

In the example illustrated in FIG. 16, when a non-TIM STA wakes up from the sleep mode, the non-TIM STA senses a channel before transmitting a PS-Poll/trigger/data/RTS frame. If the channel is idle, the non-TIM STA transmits the PS-Poll/trigger/data/RTS frame. If the non-TIM STA fails to receive a response frame for the transmitted PS-Poll/trigger/data/RTS frame, the non-TIM STA defers retransmission of the PS-Poll/trigger/data/RTS frame. Then, the non-TIM STA transmits the PS-Poll/trigger/data/RTS frame via the backoff process only after detecting/receiving a beacon frame.

In the example of FIG. 16, STA1 may acquire a TXOP via exchange of RTS/CTS and transmit a data frame to the AP. While STA1 is performing TXOP-related operation, STA2, which is a non-TIM STA, may wake up from the sleep mode and check if the channel is idle for the PD. Thereafter, STA2 may perform the backoff process for a RBO time, and then transmit a PS-Poll frame.

If STA2 fails to receive an ACK frame for the transmitted PS-Poll frame after a predetermined time (e.g., SIFS), STA2 does not perform the backoff process for retransmission of the PS-Poll frame, but defers transmission of the PS-Poll frame. Transmission of the PS-Poll frame is deferred until STA2 receives a beacon frame. In other words, if the channel is idle when the non-TIM STA wakes up from the sleep mode, the non-TIM STA may attempt channel access for the first time. If the first channel access is not successful, the non-TIM STA may be allowed to attempt channel access according to the EDCA scheme for the second time after confirming that the channel is idle only if the beacon frame is detected/received.

In the example of FIG. 16, if STA2 fails to receive an ACK frame for the PS-Poll frame that STA2 woke up and transmitted for the first time, STA2 may defer retransmission of the PS-Poll frame. STA2 may continue to defer transmission of the PS-Poll frame even if STA2 detects an ACK or BA frame from the AP. STA2 may retransmit the PS-Poll frame via the backoff process only after detecting a beacon frame from the AP.

In contrast with example of FIG. 15, the example of FIG. 16 requires a beacon frame to be received to reattempt channel access. In this case, when the non-TIM STA fails to perform channel access for the first time, the non-TIM STA may enter and stay in the sleep mode until the next beacon frame is received. Thereby, power may be further saved.

Description has been given above of various examples of the present invention on the assumption that a non-TIM STA (or an STA allowed to perform active polling) wakes up and transmits a PS-Poll frame. The principle employed in the description may also be applied to a case where a non-TIM STA (or an STA allowed to perform active polling) wakes up and transmits a trigger frame or data frame. If the non-TIM STA (or the STA allowed to perform active polling) wakes up and attempts to transmits a data frame, the process of exchanging an RTS/CTS frame may be additionally performed before the data frame is transmitted.

Specifically, the non-TIM STA (or the STA allowed to perform active polling) may wake up at a scheduled time (e.g., a target awake time (TWT)) or an unscheduled time to transmit a PS-Poll frame or a trigger frame. The STA may directly transmit a data frame, or may transmit an RTS frame in order to transmit the data frame. The proposed principle of the present invention may be applied to all those cases.

FIG. 17 is a diagram illustrating transmission of a data frame by a non-TIM STA according to an embodiment of the present invention.

In the example of FIG. 17, if the channel is idle when STA2 wakes up from the sleep mode, STA2 transmits a data frame. If STA2 fails to receive a response to the data frame, STA2 defers retransmission of the data frame, and then attempts retransmission of the data frame via the backoff process according to the EDCA scheme when a frame from another STA (e.g., an ACK/BA frame from the AP) is detected. This method may be similar to the PS-Poll transmission scheme of FIG. 15.

Alternatively, if the channel is idle when STA2 wakes up from the sleep mode, STA2 may transmit a data frame first. If a response to the data frame is not received, STA2 may defer retransmission of the data frame, and attempt retransmission of the data frame via the back process according to the EDCA scheme when a beacon frame from the AP is detected (namely, in a manner similar to the PS-Poll transmission scheme of FIG. 16).

Alternatively, even if the channel is idle when STA2 wakes up from the sleep mode, STA2 may defer transmission of a data frame rather than immediately transmitting the data frame. Thereafter, STA2 may attempt transmission of the data frame via the backoff process according to the EDCA scheme when a frame from another STA is detected/received (namely, in a manner similar to the PS-Poll transmission scheme of FIG. 14).

FIG. 18 is a diagram illustrating transmission of an RTS frame by a non-TIM STA according to an embodiment of the present invention.

When a non-TIM STA wakes up from the sleep mode, the non-TIM STA senses a channel. If the channel is idle for the PD, the STA may transmit an RTS frame via the backoff process according to the EDCA scheme before transmitting a UL data frame. If the non-TIM STA receives a CTS frame in response to the transmitted RTS frame, the STA may be allowed to transmit the data frame.

In the example of FIG. 18, if the channel is idle when STA2 wake up from the sleep mode, STA2 transmits an RTS frame first. If STA2 fails to receive a response (e.g., a CTS frame) to the RTS frame, STA2 defers retransmission of the RTS frame. When a frame from another STA (e.g., an ACK/BA frame from the AP) is detected, STA2 attempts retransmission of the RTS frame via the backoff process according to the EDCA scheme. This method may be similar to the PS-Poll transmission scheme of FIG. 15.

Alternatively, if the channel is idle when STA2 wakes up from the sleep mode, STA2 may transmit an RTS frame first. If STA2 fails to receive a response to the data frame, STA2 may defer retransmission of the RTS frame. When a beacon frame from the AP is detected, STA2 may attempt retransmission of the RTS frame via the backoff process according to the EDCA scheme (namely, in a manner similar to the PS-Poll transmission scheme of FIG. 16).

Alternatively, even if the channel is idle when STA2 wakes up from the sleep mode, STA2 may defer transmission of the RTS frame rather than immediately transmitting the RTS frame. Thereafter, STA2 may attempt transmission of the RTS frame via the backoff process according to the EDCA scheme when a frame from another STA is detected/received (namely, in a manner similar to the PS-Poll transmission scheme of FIG. 14).

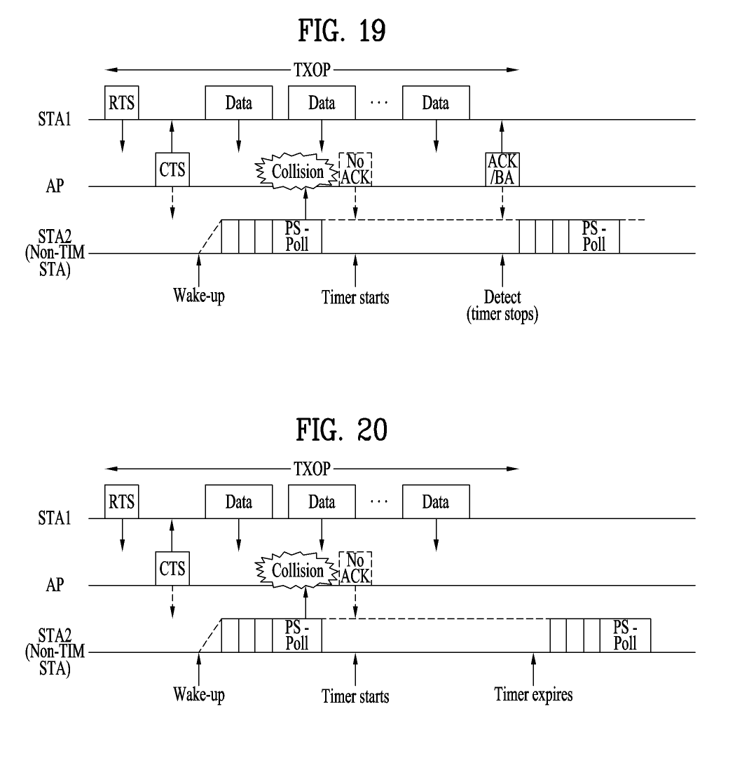

FIGS. 19 and 20 illustrate use of a timer for deferring channel access by a non-TIM STA according to embodiments of the present invention.

In the examples of FIGS. 19 and 20, when a non-TIM STA wakes up from the sleep mode, the non-TIM STA senses a channel before transmitting a PS-Poll/trigger/data/RTS frame. If the channel is idle, the non-TIM STA transmits the PS-Poll/trigger/data/RTS frame. If the non-TIM STA fails to receive a response frame for the transmitted PS-Poll/trigger/data/RTS frame, the non-TIM STA may defer retransmission of the PS-Poll/trigger/data/RTS frame for a predetermined time.

Herein, the predetermined time may be determined based on a predetermined timer. For example, the time may start at the time at which the non-TIM STA transmits the PS-Poll/trigger/data/RTS frame. Alternatively, the predetermined timer may start if it is determined that a response frame for the PS-Poll/trigger/data/RTS frame transmitted from the non-TIM STA has not been received at the time at which the non-TIM STA was supposed to receive the response frame. That is, while the timer is running, channel access may be prohibited or deferred.

Only if a frame or beacon frame from another STA is detected/received while the timer is running, the non-TIM STA may transmit the PS-Poll/trigger/data/RTS frame via the backoff process. If a frame or beacon frame from another STA is detected/received while the timer is running, the timer may be stopped. If a frame or beacon frame from another STA is not detected/received while the timer is running, the non-TIM STA may transmit the PS-Poll/trigger/data/RTS frame via the backoff process when the timer expires. The time to attempt transmission of a PS-Poll/trigger/data/RTS frame after the timer starts may be an earlier time of the reception time of a frame from another STA (or a beacon frame from the AP) and the expiration time of the timer.

In the example of FIG. 19, if the channel is idle when STA2 wakes up from the sleep mode, STA2 may transmit a PS-Poll frame. Thereafter, if STA2 fails to receive an ACK frame, STA2 may start a PS-Poll timer. While the timer is running, retransmission of the PS-Poll frame is deferred. If a frame from another STA (e.g., an ACK/BA frame from the AP) or a beacon frame is detected while the timer is running, STA2 may attempt retransmission of the PS-Poll frame via the backoff process according to the EDCA scheme.

In the example of FIG. 20, if the channel is idle when STA2 wakes up from the sleep mode, STA2 may transmit a PS-Poll frame. Thereafter, if STA2 fails to receive an ACK frame, STA2 may start a PS-Poll timer. While the timer is running, retransmission of the PS-Poll frame is deferred. When the timer expires, STA2 may attempt retransmission of the PS-Poll frame via the backoff process according to the EDCA scheme even if a frame from another STA (e.g., an ACK/BA frame from the AP) or a beacon frame has not been detected.

The timer employed in the examples of FIGS. 19 and 20 may be set to a value greater than that of the PD. In addition, the timer may be set to a value equal to the maximum TXOP duration. However, embodiments of the present invention are not limited thereto. The timer may be set to a proper value according to the network policy, performance of the STA, manipulation by a user, and the like.

If the non-TIM STA fails to transmit a PS-Poll/trigger/data/RTS frame, the non-TIM STA may wait/defer transmission for a predetermined time as in the proposed various examples of the present invention. Thereafter, the STA may perform the backoff process according to RBO or ERBO, and then attempt retransmission of the PS-Poll/trigger/data/RTS frame. In retransmitting the PS-Poll/trigger/data/RTS frame, performing the backoff process according to ERBO is similar to the operation of the STA that is conventionally defined, and thus may be more preferable than defining a new operation of the STA, which may result in high complexity.

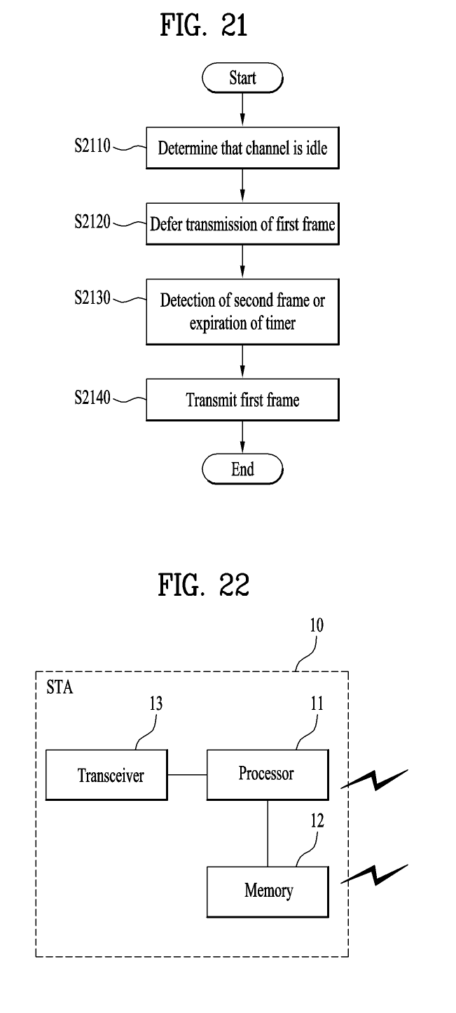

FIG. 21 illustrates a method for channel access by a non-TIM STA according to an embodiment of the present invention.

In step S2110, a non-TIM STA may determine, through channel sensing, that a channel is idle. That is, it is assumed that the non-TIM STA determines that the channel is idle through a virtual carrier sensing mechanism such as NAV.

In step S2120, the non-TIM STA may defer transmission of a first frame (e.g., a PS-Poll frame, trigger frame, data frame or RTS frame). According to the legacy operation of the non-TIM STA, when the channel is determined to be idle, the STA may attempt channel access. According to the proposed operation of the non-TIM STA, on the other hand, the non-TIM STA is allowed to attempt channel access only when the channel is idle and additional conditions are met.

In step S2130, the non-TIM STA may attempt transmission of the first frame if a second frame (e.g., a frame from another STA or a beacon frame from an AP) is received or a predetermined timer expires. For example, if either reception of the second frame or expiration of the predetermined timer occurs first, the non-TIM STA may attempt transmission of the first frame.

In step S2140, the non-TIM STA may transmit the first frame if the conditions of steps S2110 and S2130 are met.

Additionally, if the channel is idle when the non-TIM STA wakes up before step S2110, the non-TIM STA may transmit the first frame for the first time. In this case, deferring transmission of the first frame is not considered (namely, whether or not the condition described in step S2130 is not considered), and the first frame may be transmitted only if the channel is idle. In this case, step S2110 may be performed when the first transmission of the first frame fails (namely, reception of a response frame for the first frame fails). That is, steps S2110 to S2140 may be applied to retransmission of the first frame after failure of transmission of the first frame. In this case, the predetermined timer may start when the first frame is transmitted for the first time or when it is determined that transmission of the first frame has failed.

While FIG. 21 illustrates the operations as being performed in series for simplicity of description of the illustrated method, the order of the steps is not limited thereto. When necessary, the illustrated steps may be performed simultaneously or in a different order. In addition, not all steps illustrated in FIG. 21 may be needed to implement the method proposed in the present invention.

In implementing the method of the present invention described above, the various embodiments of the present invention described above may be independently applied or two or more embodiments may be simultaneously applied.

FIG. 22 is a block diagram illustrating a radio frequency apparatus according to one embodiment of the present invention.

An STA 10 may include a processor 11, a memory 12, and a transceiver 13. The transceiver 13 may transmit/receive a radio frequency signal and implement, for example, a physical layer according to an IEEE 802 system. The processor 11 may be connected to the transceiver 13 to implement a physical layer and/or MAC layer according to an IEEE 802 system. The processor 11 may be configured to perform various operations of an STA according to the various embodiments of the present invention described above. In addition, a module to perform operations of the STA according to the various embodiments of the present invention described above may be stored in the memory 12 and executed by the processor 11. The memory 12 may be contained in the processor 11 or may be installed at the exterior of the processor 11 and connected to the processor 11 by a well-known means.

The processor 11 of the STA 10 may be configured to implement various embodiments of the present invention in which the STA operating in the non-TIM mode in a WLAN system performs channel access. The processor 11 may be configured to perform channel sensing. If it is determined that the channel is idle, the processor 11 may defer transmission of a first frame (e.g., a PS-Poll frame, trigger frame, data frame or RTS frame) until a second frame from another STA (e.g., a frame from another STA or a beacon frame from the AP) is detected or a predetermined timer expires. If the second frame is detected or the predetermined timer expires, the processor 11 ma transmit the first frame using the transceiver 13.

In implementing constituents of the STA, various embodiments of the present invention described above may be independently applied or two or more embodiments may be simultaneously applied. For clarity, redundant descriptions are omitted.

The embodiments of the present invention described above may be implemented by various means. For example, the embodiments of the present invention may be implemented by hardware, firmware, software, or a combination thereof

When implemented by hardware, a method according to embodiments of the present invention may be implemented by one or more ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, and the like.

When implemented by firmware or software, a method according to the embodiments of the present invention may be implemented in the form of a module, a procedure, a function, or the like which performs the functions or operations described above. Software code may be stored in a memory unit and executed by the processor. The memory unit may be disposed inside or outside the processor to exchange data with the processor through various well-known means.

Detailed descriptions of preferred embodiments of the present invention have been given to allow those skilled in the art to implement and practice the present invention. Although descriptions have been given of the preferred embodiments of the present invention, it will be apparent to those skilled in the art that various modifications and variations can be made in the present invention without departing from the spirit and scope of the present invention. Thus, the present invention is not intended to be limited to the embodiments described herein, but is intended to have the widest scope consistent with the principles and novel features disclosed herein.

### INDUSTRIAL APPLICABILITY

Various embodiments of the present invention have been described through examples applied to IEEE 802.11, but they may also be equally applied to various wireless access systems other than IEEE 802.11.

1. A method for performing channel access by a station (STA) in a wireless local area network (WLAN), the method comprising:
deferring, if a channel is idle, transmission of a first frame until a second frame from another STA is detected; and
transmitting the first frame when the second frame is detected.

2. The method according to claim 1, wherein deferring transmission of the first frame is performed if the channel is determined to be idle when the STA wakes up.

3. The method according to claim 1, wherein deferring transmission of the first frame is performed if the STA transmits the first frame when the STA wakes up, but fails to receive a response frame for the transmitted first frame.

4. The method according to claim 3, wherein transmitting the first frame when the STA wakes up comprises:
transmitting the first frame without deferring transmission of the first frame when the channel is determined to be idle.

5. The method according to claim 1, wherein a timer is set for the STA, wherein transmission of the first frame is prohibited while the timer is running.

6. The method according to claim 5, wherein the first frame is transmitted when the timer expires before the second frame is detected.

7. The method according to claim 5, wherein the timer is stopped when the second frame is detected before the timer expires.

8. The method according to claim 5, wherein the timer starts when the STA wakes up and transmits the first frame, or
when a response frame for the first frame transmitted when the STA wakes up is not received.

9. The method according to claim 8, wherein transmitting the first frame when the STA wakes up comprises:
transmitting the first frame without deferring transmission of the first frame when the channel is determined to be idle.

10. The method according to claim 5, wherein a length of the timer is set to a maximum transmission opportunity (TXOP) duration.

11. The method according to claim 1, wherein transmitting the first frame comprises:
transmitting the first frame after performing a backoff process.

12. The method according to claim 1, wherein the first frame is one of a power save (PS)-Poll frame, a trigger frame, a data frame and a request to send (RTS) frame.

13. The method according to claim 1, wherein the second frame is either a frame from another STA or a beacon frame from an access point (AP).

14. The method according to claim 1, wherein the STA is a non-traffic indication map (TIM) STA.

15. A station (STA) for performing channel access in a wireless local area network (WLAN), the STA comprising:
a transceiver; and
a processor,
wherein the processor is configured to:
defer, if a channel is idle, transmission of a first frame until a second frame from another STA is detected; and
transmit the first frame using the transceiver when the second frame is detected.
